(19) United States
(12) Patent Application Publication
(10) Pub. No.: US 2014/0314918 A1
(43) Pub. Date: Oct. 23, 2014

(54) Juice Containing Pouch and Press for Extracting Juice from the Pouch

(71) Applicants: Dale Wettlaufer, Ssarasota, FL (US); Charles Wettlaufer, Las Vegas, NV (US)

(72) Inventors: Dale Wettlaufer, Ssarasota, FL (US); Charles Wettlaufer, Las Vegas, NV (US)

(21) Appl. No.: 14/229,940

(22) Filed: Mar. 30, 2014

Related U.S. Application Data
(60) Provisional application No. 61/813,956, filed on Apr. 19, 2013.
(60) Provisional application No. 61/814,015, filed on Apr. 19, 2013.
(60) Provisional application No. 61/861,983, filed on Aug. 3, 2013.
(60) Provisional application No. 61/888,632, filed on Oct. 9, 2013.

(51) Int. Cl. B65D 83/00; B65D 33/16; A23L 2/02; B65D 33/00

(52) U.S. Cl. CPC B65D 83/0061; B65D 33/00; B65D 33/16; A23L 2/02
USPC 426/115; 383/37; 383/42

(57) ABSTRACT

A multi-layer pouch assembly consisting of one or multiple inner sealed pouches that contain the ground produce or other product, and a surrounding mesh pouch or bag, acting as a filter for the juice contained in the inner pouches. The outer mesh or gauze pouch which completely envelops or surrounds the inner produce containing pouches has a volume at least equal to the total volume of the inner pouches, to allow for the pressing and expansion of the ground produce when the inner bags are burst by a press platen. Another alternative embodiment employs a third outermost sealable plastic pouch that is capable of holding the gauze bag or pouch, which holds the produce-containing pouches. This outer pouch can be sealed and serves as the package and container for storage in refrigerators or suitable storage facilities.

### TECHNICAL FIELD

The present invention relates to pouches that hold a liquid containing mass and more particularly, to a pouch that holds ground fruit or vegetables which may be placed directly into a juice press for juice extraction. The pouch may be a three-layer pouch and alternatively, a two-layer pouch. The inner layer of the three-layer pouch holds the liquid containing mass and is completely sealed and bursts under pressure. The next outermost layer acts as a filter for the liquid being extracted from the liquid containing mass in the inner pouch. The third and final outermost layer is sealed to the atmosphere and contains the other two layers inside for transporting and storage. The two layer pouch omits the final outermost layer. The illustrated press is designed for use with the pouches of this invention.

### BACKGROUND OF THE INVENTION

The phenomenon of juicing in the home is a well regarded and popular way to maintain a healthy diet and to help lose weight. Most recently, fresh juice is also being used in a regimen called “cleansing” which has recently gained popularity as a health promoting method.

Home juicers have been with us for many years. Noteworthy types are the screw press exemplified by the Champion, the centrifuge, as practiced by Acme, and the hydraulic press, as exemplified by Norwalk.

Although the methods of shredding and applying pressure differ, all these machines involve several steps of operation. Initially (step 1) involves searching for a recipe for the particular juice to be produced. Then in (step 2) is the procurement of all the items on the recipe at a supermarket or produce store. In (step 3) the produce is hand washed, sliced to size by hand, and in (step 4) the pieces are forced down a tube against some sort of rotating shredder plate or drum, until a coarse puree consistency is reached, which is often referred as the grinding step of juicing. Then in (step 5) the liquid containing mass or slurry is introduced into the pressing section where the juice is expressed by G forces, screw auger, or hydraulic pressure. There is then often a (6th step), the filtration step where the juice is run through some sort of screen or filter to remove the larger particles. After use the juicer must be disassembled (step 7) and the several pieces cleaned and wiped down (step 8) to prevent bacterial growth.

Unfortunately many well-intentioned people buy a juicer without fully comprehending all the work involved, and after using it a couple of times, relegate the juicer to the furthest reaches of the storage cabinet, never to be seen again.

### PRIOR ART

U.S. Pat. No. 5,277,810 shows a reusable container for use in a Norwalk hydraulic juice press. This container is to be filled with ground produce by the home user, and then inserted into the press. The juice is allowed to escape from the container through a filter in the bottom. After juice extraction is complete, the container may be washed and reused. The invention does not solve many of the problems that are addressed in this present invention. Particularly, the reusable container does not eliminate the laborious task of shopping, grinding, and squeezing produce. Furthermore, this reusable container is not made from cheap material that is meant to be disposed of after use. Furthermore, this reusable container does not allow for processing of the ground produce, such as pasteurization.

U.S. Pat. No. 3,159,096 relates to a pouch for packaging and juicing citrus fruit. The invention is basically a bag with holes on the bottom that allow the juice to flow from the package when the package is squeezed under pressure. The holes are initially covered with a seal that may be removed when desired. This invention does not lend itself to ground produce, as the solid particles of produce will either flow through the holes contaminating the juice, or clog the holes therefore not allowing juice to escape. Furthermore, the pouch is not manufactured in such a way that it may be processed by high pressure pasteurization (hereinafter HPP) or other similar processes. The package shown in this patent is not designed to be placed into a juice press, and would break in unfavorable ways allowing solid particles of produce to escape from the package, thereby contaminating the juice. Also, the package is not manufactured in such a way that allows processing of the produce, such as pasteurization.

U.S. Pat. No. 4,539,793 relates to a process for creating a burstable pouch. This burstable pouch may work fine as a storage pouch for ground produce, but it is not intended to be placed into a juice press. The bursting bag would allow solid particles of ground produce to escape the package, thereby contaminating the juice.

US published applications US2011/0076361 and US 2012/9321756 disclose containers for use in Keurig coffee makers, which containers have dehydrated fruit or vegetables therein, and which may be rehydrated and filtered.

### OBJECTS AND SUMMARY OF THE INVENTION

It is an object of this invention to provide a pouch which may be filled and processed at a remote location with a liquid containing mass such as a juice containing product, which pouch may be shipped to a point of use, and then be squeezed in a press of this invention to express the juice, the press requiring minimal cleanup.

This invention provides:

1. Convenience: The first aim or purpose of the present invention is to make juicing a quick and easy experience. This current pouch design allows for a simple 3-step process to home juicing. A consumer only has to (step 1) purchase the special pouch, insert the pouch (step 2) into the press for juice extraction, and finally (step 3) clean the press by simply discarding the used package and wiping down the press. The entire process will take considerably less time than the current methods of home-juicing.

2. Recipes: The second accomplishment of this invention is to ensure that the juice enthusiast can obtain access to secret or proprietary juice recipes to use in their own juicer. The ingredients for this new package may be chosen, mixed, and prepared by third party processors and sold in ready-to-juice pouches.

3. Access to rare produce: The third accomplishment of this invention is to give the juice enthusiast easy access to fruits or vegetables not normally found in supermarkets or produce markets. Some of these items might be acerola cherries, gogi berries, or acai fruit all of which are grown in certain remote parts of the world. By putting the shredders and pouch filling equipment in the place where the fruits are harvested and grown, the products can be prepared and packaged in a ready-to-juice form, then shipped to any part of the world.

4. Better quality produce: The fourth accomplishment of this invention is to enable the home juice enthusiast to obtain better quality produce, harvested under more ideal conditions, and cleaned properly in industrial grade facilities. It is commonly known that most fruits and vegetables are harvested early before being completely ripe, in order to withstand the holding times involved in storage and shipment often to foreign countries. When found in a supermarket, most produce is either not yet ripe, or overripe and most consumers cannot accurately tell which is which. Thus, they cannot detect when fruit or vegetables are at optimum degrees of ripeness for juicing. The present invention allows produce to be ground and packaged and shipped at optimum freshness, whether it is raw or to be frozen, or pasteurized.

5. Food Safety: The fifth accomplishment of this invention is to promote food safety. It is well known that pathogenic bacteria is most commonly found on the surface of fruit and vegetables, especially those certified as “organic” where manure is often used as fertilizer. With some products like leafy green vegetables and sprouts, it is exceedingly difficult to effectively wash and sanitize produce in the home. By putting the point of grinding in the factory where the fruit is being graded, it can be washed on commercial industrial equipment, and more importantly, after filling the pouch, the sealed pouch can be sent through any number of commercially available methods of pasteurization, including thermal, HPP (high pressure processing), or simply flash frozen.

6. Easy disposal and cleanup: The sixth accomplishment of this invention is to provide for easy disposal of waste material, and extremely easy cleanup. The pouches are disposed of in garbage or recycled, and the relevant parts of the press can be wiped down for cleaning. The pouches don't leave behind any solid fruit or vegetable matter.

Key elements to the above are as follows:

1. A multi-layer pouch assembly consisting of one or multiple inner sealed pouches that contain the ground produce or other product, and a surrounding mesh pouch or bag, acting as a filter for the juice contained in the inner pouches. The outer mesh or gauze pouch which completely envelops or surrounds the inner produce containing pouches has a volume at least equal to the total volume of the inner pouches, to allow for the pressing and expansion of the ground produce when the inner bags are burst by a press platen. Another alternative embodiment employs a third outermost sealable plastic pouch that is capable of holding the gauze bag or pouch, which holds the produce-containing pouches. This outer pouch can be sealed and serves as the package and container for storage in refrigerators or suitable storage facilities.

2. The innermost pouch or pouches are of a shape that is easily filled and sealed on standard commercial pouch filling equipment, i.e. rectangular or triangular. Preferably the material of these inner pouches is suitable for thermal or high pressure pasteurization prior to being enclosed in the filter membrane. Such pouches are typically a single layer of foil sandwiched between two layers of plastic, but many different types of pouches may be used.

3. The filter bag or filter membrane which surrounds the inner pouches can be of strong heat-sealable paper, or more preferably, unbleached cotton gauze, commonly known as “cheese cloth”. This filter bag is large enough in volume and strong enough to completely contain the contents of the inner pouches without bursting itself even under the pressure of a pressing platen which can burst the inner pouches.

4. If a drip-free operation is desired, a third outermost pouch can he used, typically of common biodegradable plastic material which preferably can have an elongated spout or “elephants trunk” on one end, through which the escaping juice may travel on its way out of the assembly. This elongated spout would be sealed until just before use, during which time the end would be snipped off or torn off in order to present an outlet path for the escaping pressed juice. It would be capable of keeping the pressing device (see co-filed patent application for a press) completely dry and untouched by food product or juice.

5. The present invention multi-layer pouch should be pressed in a special press that has a chamber or tray supporting the bottom of the pouch as the press platen squeezes the two faces of the pouch together. This totally encloses the pouch area, so that in case even the outer pouch should rupture, the mess will be contained in the removable tray.

The foregoing objects and advantages of this invention will become more apparent after a consideration of the following detailed description taken in conjunction with the accompanying figures which illustrate preferred forms of this invention.

### BRIEF DESCRIPTION OF THE FIGURES

FIG. 1 shows a perspective view of a two-pouch embodiment of the present invention including a triangular inner plastic pouch inside an outer gauze bag or pouch which is considerably bigger than the triangular inner pouch it contains.

FIGS. 2A-2C show three differing embodiments of a two-pouch system; in which the inner pouch may be triangular, pentagonal, or square, which pouches are positioned inside a larger round gauze bag or pouch. The upper row A1-C1 shows the two pouch embodiments prior to squeezing, and the lower row A2-C2 shows the inner pouches ruptured under pressure, their contents being disgorged inside the outer gauze bag.

FIG. 3 shows a triple pouch system, where the 3 inner pouches are sausage shaped, the inner pouches being inside a gauze layer or bag, which itself is contained in the outer sealed pouch provided with a juice exit trunk.

FIGS. 4-6 show the pouch of FIG. 3 in a press designed for a pouch system having a juice exit trunk, in FIG. 4 a full pouch is shown below a piston which is in a retracted position, in FIG. 5 the piston is shown in a lowered position, the pouch being fully compressed, and in FIG. 6 the piston is again shown in a retracted position so the squeezed pouch may be removed.

### DETAILED DESCRIPTION

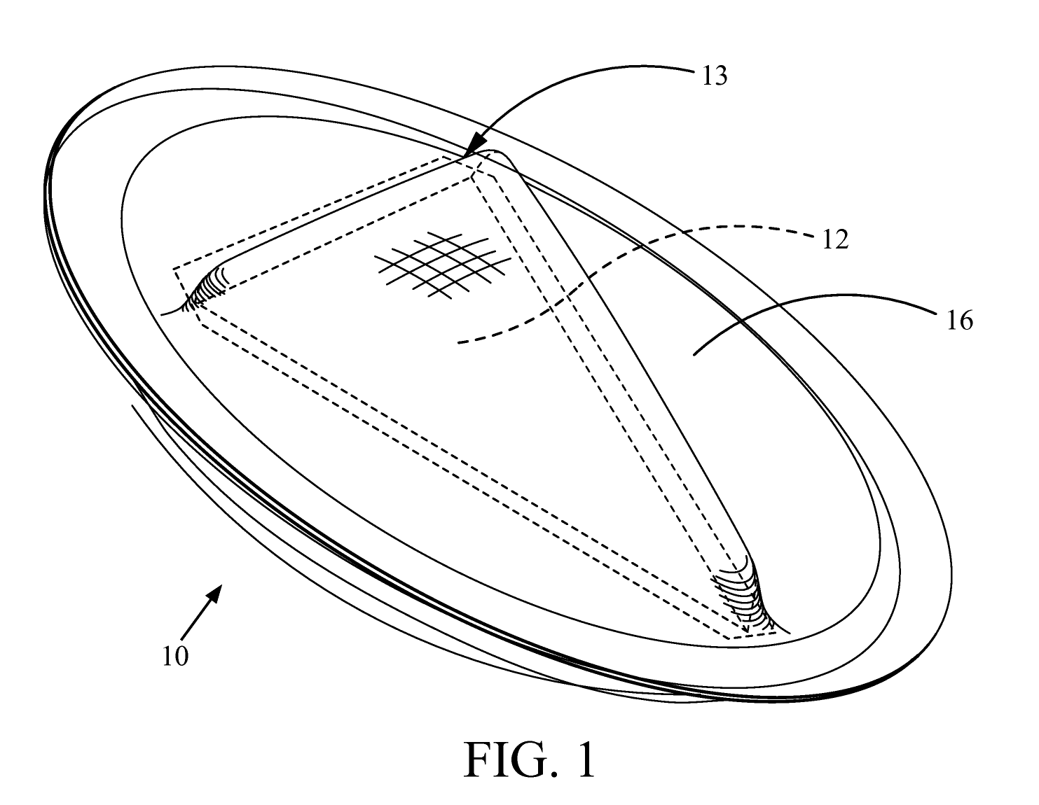

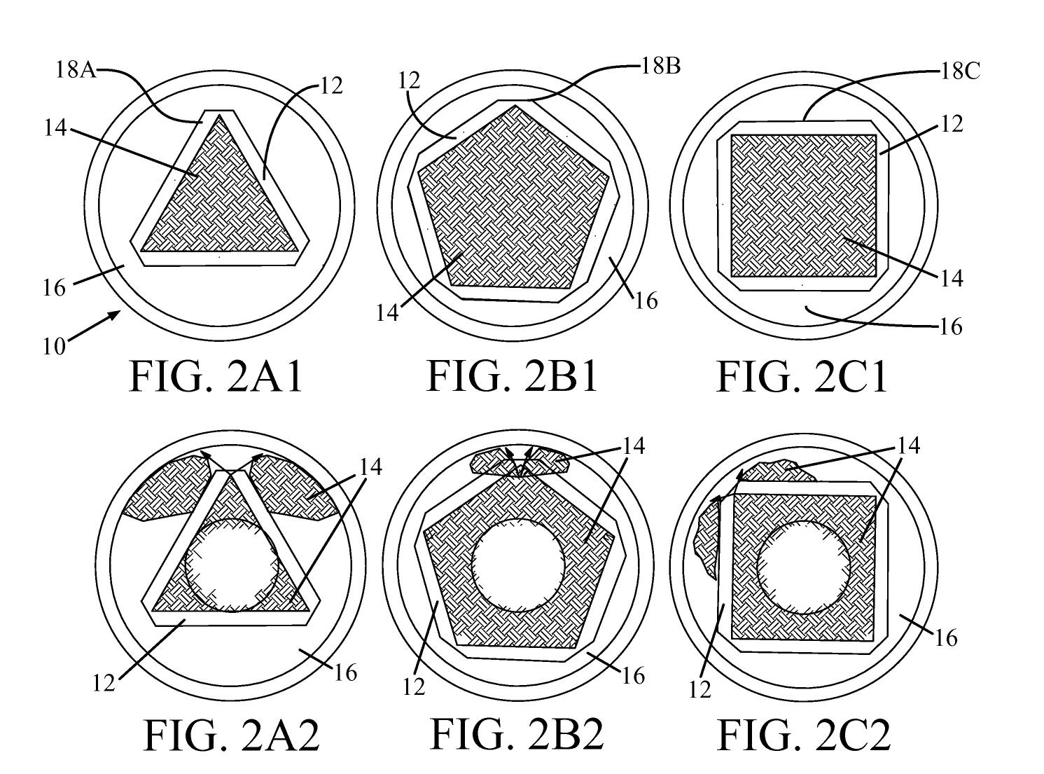

FIGS. 1 and 2A1 show a two pouch embodiment in its entirety, the two pouch assembly being indicated generally at 10. The inner pouch 12 of the two pouch assembly holds ground product 14, and the pouch 12 will burst at the seams when pressed as shown at 18A in FIG. 2A1. The outer pouch 16 is made of a filter material similar to a coffee filter or more preferably cotton gauze material such as cheesecloth and is meant to stay intact during pressing.

The ground (and/or shredded) product 14 is completely enclosed and sealed in inner pouch 12. The inner pouch may have differing shapes, such as triangular as shown in FIG. 2A1, pentagonal as shown in FIG. 2B1, square as shown in FIG. 2C1, or any other shape which may be held within the outer pouch 16. This inner pouch 12 may be made from a variety of materials depending on the intended processing of the ground produce. These pouches may be made special for high pressure pasteurization (HPP), numerous other methods of pasteurization, cold/frozen storage, or simply to hold raw product. The vital aspect of this pouch is that the seal 18 will break when there is adequate pressure applied by a juice press. After the seal bursts as shown in FIGS. 2A2-2C2 the juice and shredded vegetable material exit from the inner pouch 12, but the shredded material will be retained within the outer pouch 16, but the juice may pass through the filter material of the outer pouch. A vital aspect of this outer pouch 16 is that it is of greater size than inner pouch 12. This outer pouch 16 must be relatively large, so that during the squeezing process, the outer pouch does not burst and remains intact so as to hold back the particulates and to allow only the passage of filtered juice. After the completion of juice extraction this entire package assembly may be disposed of, making for easy cleanup.

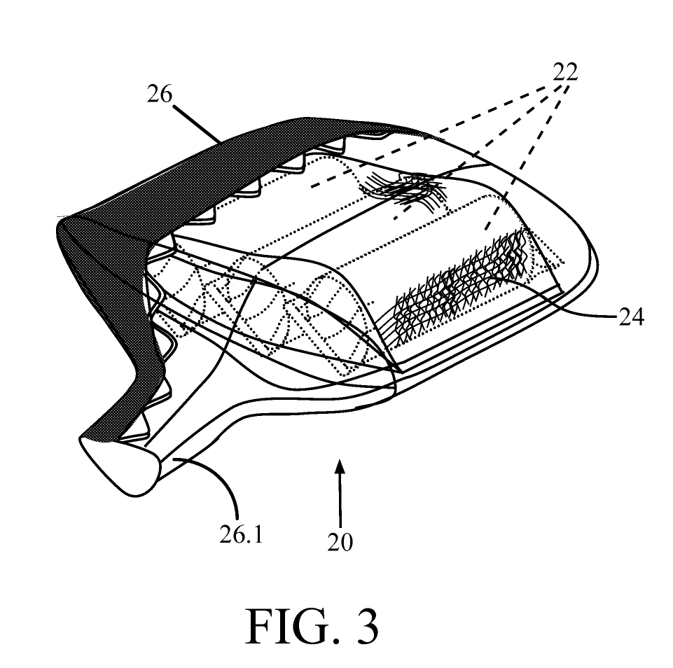

FIG. 3 is a 3 dimensional sectional sketch of the three-pouch embodiment of this invention, which is indicated generally at 20. The innermost pouches, 22, are sausage shaped, nestle inside the foraminous filter bag 24 made of gauze, which bag 24 is itself fully contained in a plastic outermost pouch 26 which is completely sealed to hold liquid inside and the air out. This outermost pouch has a juice exit trunk 26.1, which can be snipped off or torn just prior to pressing, thereby allowing the juice to exit the pouch assembly without contacting the press at all.

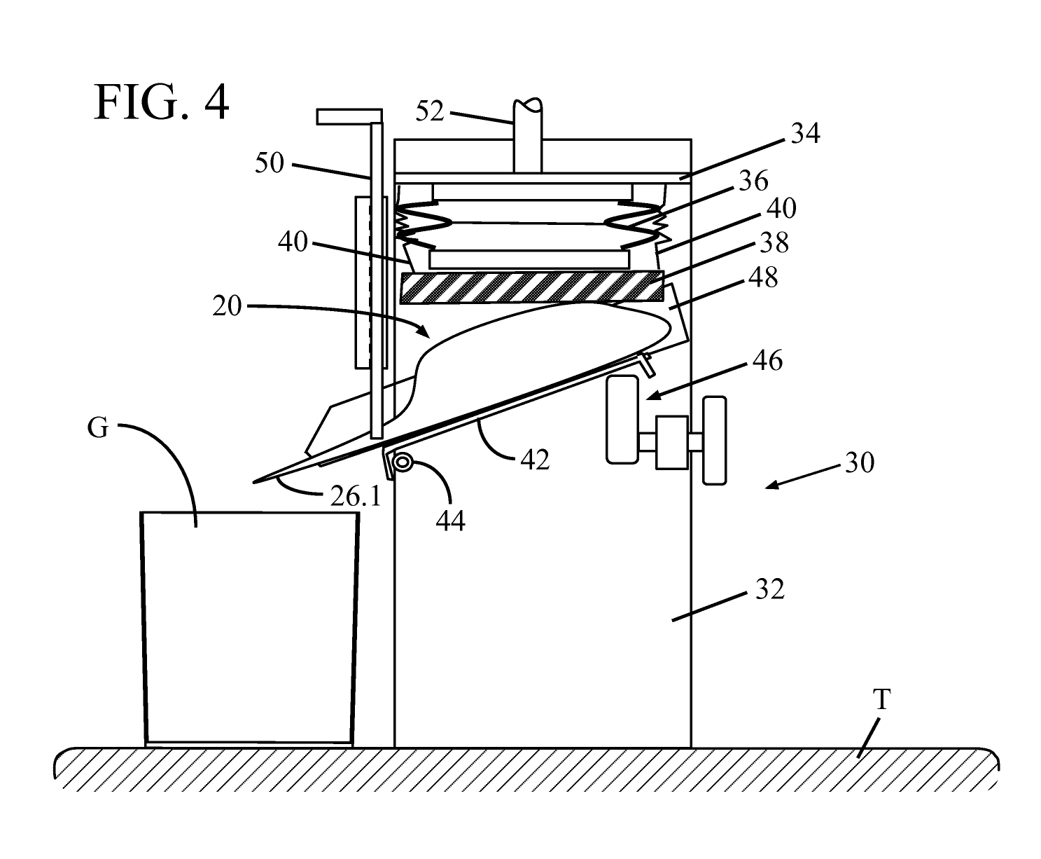

FIGS. 4-6 show a press indicated generally at 30. It is made especially for the pressing the pouch of FIG. 3, although it may be used for the pouches shown in FIGS. 2 The press includes a generally tubular structure 32 which may rest on the top of a table “T” or the like. A plate 34 is carried adjacent the top of the tubular structure 32. Mounted within the structure 32 below the plate 34 is a standard air bladder assembly 36, more commonly called an “air spring”. This rugged type of air bladder is self-contained as regards sealing to the outside, and the “upper” side can be simply mounted to the top plate 34 with common bolts and the “lower” side to a moving piston 38 also with common bolts. The piston 38 is preferably made of flexible material such as thick rubber or plastic. Return springs 40 are provided, each being secured at one end to top plate 34, and at the other end to piston 38, the return spring holding the piston in the “up” position as shown in FIG. 4. Mounted below the piston 38 is a support plate 42 which is mounted for tilting movement. Thus one end is pivotally mounted on pivot pin 44 and the other end is supported by an adjustable cam mechanism indicated generally at 46. A pouch receiving tray 48 is carried by the support plate 42. A sliding door 50 is carried by the tubular structure 32 above the pivot pin 44.

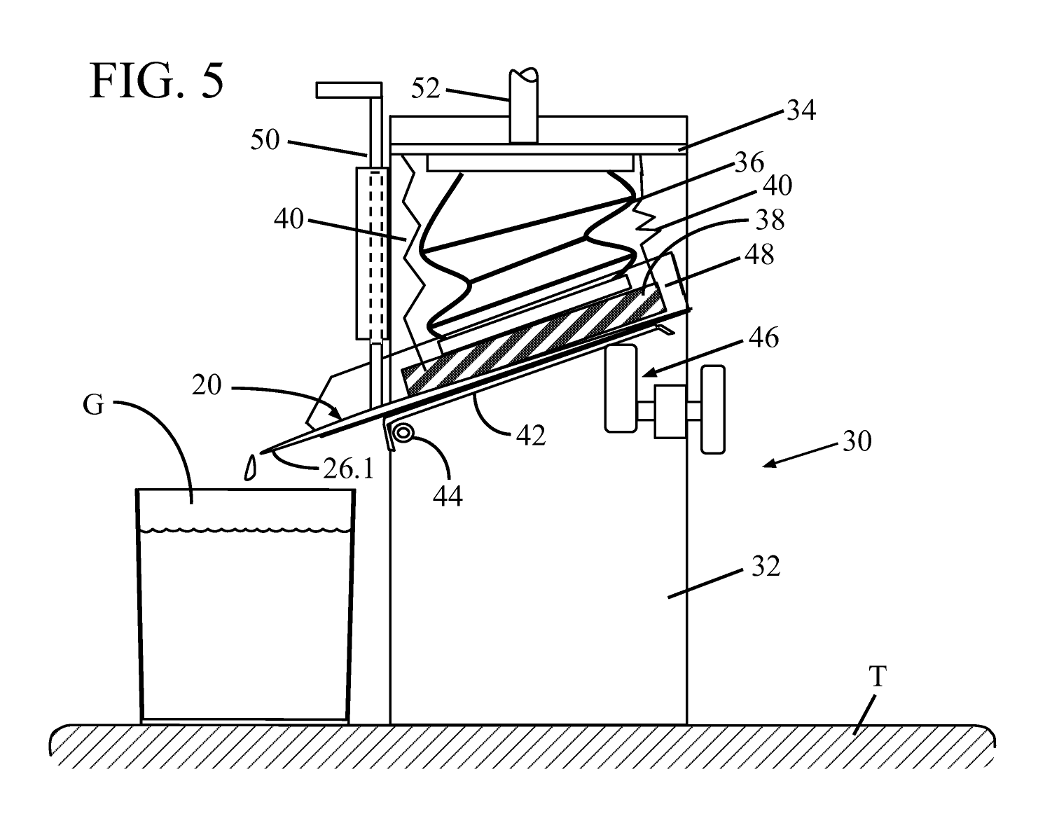

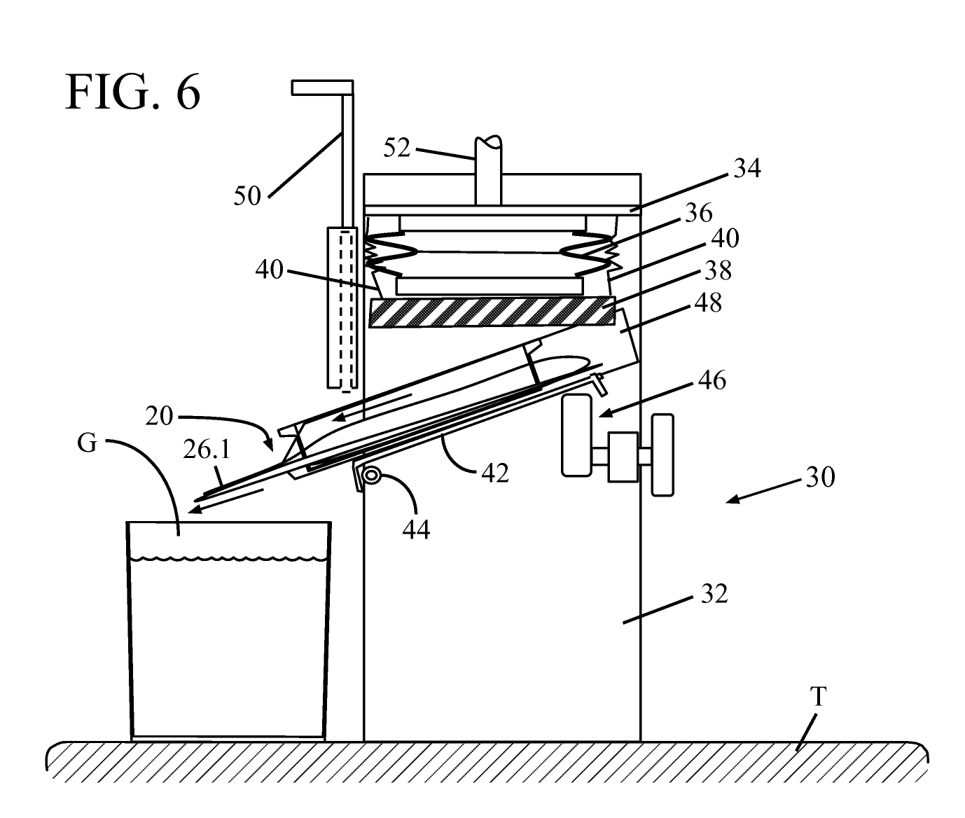

In operation, the press will be loaded by sliding the door 50 to its raised position as shown in FIG. 6, and placing a full pouch 20 on the tray 48. During loading the piston 38 will be held in its raised position by the return springs 40. After the pouch has been loaded the sliding door will be moved to its closed position as shown in FIG. 4. Compressed air will now be admitted into the air bladder assembly 36 via a suitable fitting which is illustrated at 52. This will causes the air bladder to extend to the fully extended position as shown in FIG. 5, preferably about 2 to 3 inches of stroke, and the liquid containing mass in the pouch is suitably squeezed flat, the expressed juice flowing out through trunk 26.1 into a suitable container, such as glass “G”. At the completion of the pressing operation the door 50 is raised as shown in FIG. 6, and the squeezed pouch is removed and may be discarded. The compressed air within the bladder assembly 36 will be permitted to escape, causing the piston to return to its raised position as shown in FIGS. 4 and 6. The cycle can now be repeated. It should be noted that no part of the press has been made wet by the juice and so no cleaning is required. Instead of using compressed air, compressed CO₂ may be used. Alternatively, any suitable gas or fluid may be used.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A pouch assembly comprising:
a first pouch made of flexible polymer sheet first sealed on at least 2 sides, capable of being filled with a shredded slurry on a standard pouch filling machine, and then being sealable after filling with heat or glue so as to become sealed to the outside air and to completely contain all constituents of the slurry in a strong and durable package able to withstand thermal pasteurization or High Pressure Pasteurization treatment;
a second pouch made from a foraminous material such as paper or polymer mesh, of a similar to or greater volume than first pouch volume, attachable in some way to said first pouch so as to form a firm connection between the two, through which the contents of said first pouch can be substantially transferred into said second pouch without leakage, said second pouch being so constructed so as to filter and retain the particles, while permitting the liquid to pass through its flat sides unimpeded if subjected to a pressure differential between the inside and the outside of said second pouch, such as would occur during a pressing or dewatering operation.
a seal section in said first pouch, being weaker than any other portion of the pouch, so that it will reliably rupture before any other part of the seal, said seal point being located near to or at the connection point between the 2 pouches, such that all or substantially all of the contents of first pouch are reliably extruded into said second pouch.

2. The pouch assembly of claim 1 where the polymer slurry containing pouch is completely contained within the mesh pouch, so that after rupturing, the contents of first pouch are completely contained within said first pouch.

3. The pouch assembly of claim 1 where the connection point between the first and second pouches is joined at a restricted mouth section.

4. The pouch assembly of claim 1 where the first pouch is of roughly rectangular shape, and the mesh pouch is of a roughly circular shape.

5. The pouch assembly of claim 1 where the first pouch is of a roughly triangular shape and the second pouch is of larger volume and a different shape, such as circular or rectangular.

6. The pouch assembly of claim 1 wherein the first pouch is filled with shredded or diced food product containing liquid or juice meant for subsequent juice extraction in a pressurized device.

7. The pouch assembly of claim 1 wherein the flexible material from which it is formed is a multi-layer sandwich of polymer and metal foil to preserve and exclude air and to be heat sealable.

8. A pouch or bag assembly, capable of being filled with a shredded slurry, and then being sealable after filling with so as to become sealed to the outside air and to completely contain all constituents of the slurry in a strong and durable package able to withstand freezing, said pouch or bag, when wrapped in a gauze or cloth bag is suitable for bursting at a specified applied pressure when placed in a press or other squeezing device.

9. The pouch or bag assembly of claim 8 where the material of the bag is made of multiple layers, with an inner foil layer sandwiched between 2 plastic layers, and is easily sealable using heat.

10. A three sided disposable bag or pouch with a large open end, suitable for filling manually from a scoop or cup with a finely shredded or ground fruit or vegetable product, and after filling the open end can be simply folded over to effect a temporary seal, so that when the bag is placed within a chamber of a juice press and squeezed, the solid particles are retained until all freely available juice is squeezed out, the de-juiced bag or pouch being disposable.

11. The bag or pouch of claim 10 wherein the material of which it is constructed is a fine mesh similar or identical to standard coffee filter paper, or a strong tea bag material.

12. A multi-layer pouch assembly consisting of one or more inner sealed pouches that contain the ground produce or other product, a surrounding mesh pouch or bag, acting as a filter for the juice contained in the inner pouches, which surrounding mesh pouch or bag completely envelops or surrounds the inner produce containing pouches and has a volume at least equal to the total volume of the inner pouches to allow for the pressing and expansion of the ground produce when the inner bags are burst by a press platen, and a third outermost sealable plastic pouch that is capable of holding the gauze bag or pouch, which outer pouch can be sealed and serves as the package and container for storage in refrigerators or suitable storage facilities.
